(19) United States
(12) Patent Application Publication
(10) Pub. No.: US 2020/0126151 A1
(43) Pub. Date: Apr. 23, 2020

(54) SYSTEMS AND METHODS FOR PROVIDING BUDGET MANAGEMENT THAT INCORPORATES BUDGET REGULATED TRANSACTION ALERTS

(71) Applicant: Capital One Services, LLC, McLean, VA (US)

(72) Inventor: Elena Botella, Washington, DC (US)

(21) Appl. No.: 16/163,920

(22) Filed: Oct. 18, 2018

(51) Int. Cl. G06Q 40/02; G06Q 20/32; G06Q 20/40

(52) U.S. Cl. CPC G06Q 40/02; G06Q 20/40145; G06Q 20/407; G06Q 20/3221

(57) ABSTRACT

A system includes one or more memory devices storing instructions, and one or more processors configured to execute the instructions to perform the steps of a method for providing real time digital budget tracking using POS interaction. The system may receive user budget information from a user device. The system may then receive a purchase authorization request from a merchant device. During the authorization of the purchase, the system may determine a relevant budget category for the purchase. The system may then determine the amount remaining in the relevant budget category and compare the amount remaining to the purchase amount. Responsive to determining that the purchase amount is greater than the amount remaining in the relevant budget category, the system may transmit a user authorization request to the user device. Responsive to receiving a user authorization message, the system may authorize the merchant device to complete the transaction.

### FIELD OF INVENTION

The present disclosure relates to systems and methods for providing real time budget tracking and monitoring, and more particularly for tracking a user's purchases, notifying the user during the authorization of a purchase that would cause the use to go over budget, and prompting the user with to determine whether or not to proceed with the transaction.

### BACKGROUND

Typically, when a consumer sets out to buy goods or services, the consumer is well-advised to limit the price they are willing to spend in accordance with a budget. The consumer may create their budget based on types or classes of items, such as groceries, clothes, gas, etc., based on types of consumer experiences or outings, such as movies, travel, dining, etc., based on time and/or location, such as expenses while on vacation in Florida, expenses incurred between 8:00 pm and 11:59 pm on Thursday night, or based on other categories that fit the consumer's needs. That is, the budget may designate the maximum spending allowance towards a particular category of spending or class of items over a specified time period (e.g., $50 to spend between 8:00 pm and 11:59 pm on Thursday night, $500 on groceries this month, $200 on jeans this year, etc.). Staying within budget helps the consumer to spend within their means and save to meet long-term financial goals.

Despite the importance of making and adhering to a budget, it is often difficult, inconvenient, or impractical for even the most disciplined consumer to make and keep track of their budget as they shop at a merchant location or even online. Maintaining a budget throughout the shopping experience requires that the shopper iteratively update the budget by keeping track of expenditures, anticipating future purchasing needs, and aligning those expenditures and future purchasing needs with the purchaser's income and long-term budget goals.

Accordingly, there is a need for improved systems and methods for providing real time budget tracking and monitoring, and more particularly for tracking a user's purchases and transmitting a message to the user during the authorization of a purchase that would cause the use to go over budget. Embodiments of the present disclosure are directed to this and other considerations.

### SUMMARY

Disclosed embodiments provide systems and methods for providing real time budget tracking and monitoring, and more particularly for tracking a user's purchases and transmitting a message to the user during the authorization of a purchase that would cause the use to go over budget.

Consistent with the disclosed embodiments, the system may include one or more memory devices storing instructions, and one or more processors configured to execute the instructions to perform steps of a method to provide users the ability to track and monitor a budget in real time using point of sale warning messages. The system may receive, from a user device, user budget information comprising one or more budget categories. The system may receive, from a merchant device, a purchase authorization request associated with an attempted purchase comprising a budget indicator. Responsive to that receipt, the system may determine, based on the budget indicator, a budget category associated with the attempted purchase. The system may determine a remaining budget amount for the budget category associated with the attempted purchase. Responsive to determining the remaining budget amount, the system may compare the remaining budget amount to a transaction amount of the attempted purchase. Responsive to determining that the transaction amount exceeds the remaining budget amount, the system may transmit, to the user device, a user authorization request comprising data representing a request for the user to authorize or cancel the attempted purchase. Responsive to receiving, from the user device, a user authorization message comprising data representing an authorization of the attempted purchase, authorize the merchant device to complete the attempted purchase. Responsive to receiving, from the user device, a user cancellation message comprising data representing a cancellation of the attempted purchase, instruct the merchant device to cancel the attempted purchase.

Further features of the disclosed design, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an exemplary system that may be used for budget management incorporating budget regulated transaction alerts;

FIG. 2 is a component diagram of an exemplary budget management device;

FIG. 3 is a component diagram of an exemplary user device;

FIG. 4 is a flowchart of an exemplary method executed by a that may be used for budget management incorporating budget regulated transaction alerts;

FIG. 5 is a flowchart of an exemplary method executed by a that may be used for budget management incorporating budget regulated transaction alerts; and

FIG. 6 is a flowchart of an exemplary method executed by a that may be used for budget management incorporating budget regulated transaction alerts.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Embodiments of the present disclosure may allow a user to track and monitor a budget in real time and manage spending through budget regulated point of sale alerts. According to some embodiments, a user may enter (e.g., via user device 102) budget information (e.g., budget categories and maximum expenditures in said categories) associated with the user's account. For example, in some embodiments, the user may go to a website associated with the organization and enter their budget information. Once the budget information is entered, the user is able to track spending. In some embodiments, upon initiating a purchase, the system may receive (e.g., via transaction server 114) a request to authorize the purchase from a merchant device (e.g. via merchant POS terminal 124). In some embodiments, system may determine (e.g., via budget management device 120) a budget category from the user budget information that the purchase relates to. For example, in some embodiments system may determine the budget category based upon the type of merchant. According to some example embodiments, purchases at a grocery store may fall into the grocery budget category. In some embodiments system may determine the budget category based upon the location of the transaction(s). For example, in some embodiments, a user may set a budget category for all purchases made while on vacation in Florida. In such embodiments, system may determine the user's location based on transaction data from an initiated purchase. In other such embodiments, system may determine the user's location based on location data from a device associated with the user, as discussed further herein. In some embodiments system may determine the budget category based upon the time of the transaction(s). For example, in some embodiments, a user may set a budget category for all purchases made between 8:00 pm and 11:59 pm on a Friday night. In such embodiments, system may determine the time a transaction is initiated based on transaction data from an initiated purchase. In other such embodiments, system may determine the time a transaction is initiated based on when system receives notice of the initiated transaction. According to some embodiments, a user may set a budget category based on the type of item. According to some example embodiments, purchases of fruit, such as a banana, may fall into the grocery budget category. In such embodiments, it may be possible that items within a single transaction may fall within more than one budget category (e.g., buy a banana, which falls into a grocery budget category and also buy a shirt, which falls into a clothing budget category). In some embodiments, after determining the relevant budget category, the system may determine (e.g., via budget management device) the remaining budget amount for that category. According to some example embodiments, system may determine whether the transaction amount exceeds the determined remaining budget amount. In some embodiments, for example, if the transaction amount equals or is less than the remaining budget amount, the system may authorize the purchase. According to some embodiments, if the transaction amount is determined to exceed the remaining budget amount, the system may send a request for the user to authorize or deny the purchase (e.g., to user device 102). The user may then select whether to approve or deny the purchase (e.g., via selecting an option on user device 102). If the user chooses to complete the purchase, the system will authorize the purchase. If the user chooses to deny the purchase, the system will instruct the merchant device to cancel the purchase.

Additionally, in some embodiments, a user may desire to have the ability to track their budget in real time using geographic budget alerts in addition to the point of sale warning messages. The user may enter budget information as previously discussed. Once the budget information is entered, the user may go shopping. According to some embodiments, upon entering a merchant location, the system may receive the users location (e.g., via user device 102) and may determine a relevant budget category associated with the merchant at that location. For example, in some embodiments, user may have an application running on a user device that continuously sends location data to system (e.g., cell-tower ID, GPS, or network ID). In some example embodiments, user may open application running on a user device in order to send location data to system. In some embodiments, a beacon or other similar device may be installed at merchant location, and may transmit a signal that, when received by a user device, may trigger an application running on the user device to track the user device's location. According to some embodiments, a user may carry a transaction card (e.g., credit card) or other type of debiting device that incorporates location tracking features, such as, for example, a GPS installed in the transaction card or device. In some embodiments, after determining the relevant budget category, the system may determine (e.g., via budget management device) the remaining budget amount for that category. In some embodiments, the remaining budget amount may then be displayed to the user (e.g., via user device 102) before any purchases have been attempted. In some embodiments, after a user has completed shopping and initiates a transaction, system may complete steps similar to those previously described in order to provide the user with budget regulated point of sale alerts.

Further, in some embodiments, a user may desire to have the ability to track their budget in real time using budget regulated item selection alerts in addition to the geographic budget alerts and the budget regulated point of sale alerts. As previously described, the user may enter budget information as previously discussed. Once the budget information is entered, the user may go shopping. In some embodiments, as a user chooses an item to be purchased, merchant item sensor 122 may detect that the item has been placed in the cart. For example, in some embodiments, items to be purchased may have an ID tag integrated and merchant item sensor 122 may detect that the item has been placed in the cart. In some embodiments, merchant item sensor 122 may transmit data associated with items to user device 102. According to some embodiments, system may determine (e.g., via budget management device 120) a relevant budget category, as previously discussed. In some embodiments, after determining the relevant budget category, the system may determine (e.g., via budget management device) a provisional budget amount or the amount that would be left in the relevant budget category if the user were to purchase the item. According to some example embodiments, system may determine whether the provisional budget amount is less than zero. According to some embodiments, if the provisional budget amount is determined to be less than zero, the system may generate a warning message indicating that authorizing the purchase of the item selected by the user would cause the user to exceed the amount of money budgeted for the relevant budget category. In some embodiments, after a user has completed shopping and initiates a transaction, system may complete steps similar to those previously described in order to provide the user with budget regulated point of sale alerts.

Although the above embodiments are described with respect to systems, it is contemplated that embodiments with identical or substantially similar features may alternatively be implemented as methods and/or non-transitory computer-readable media.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

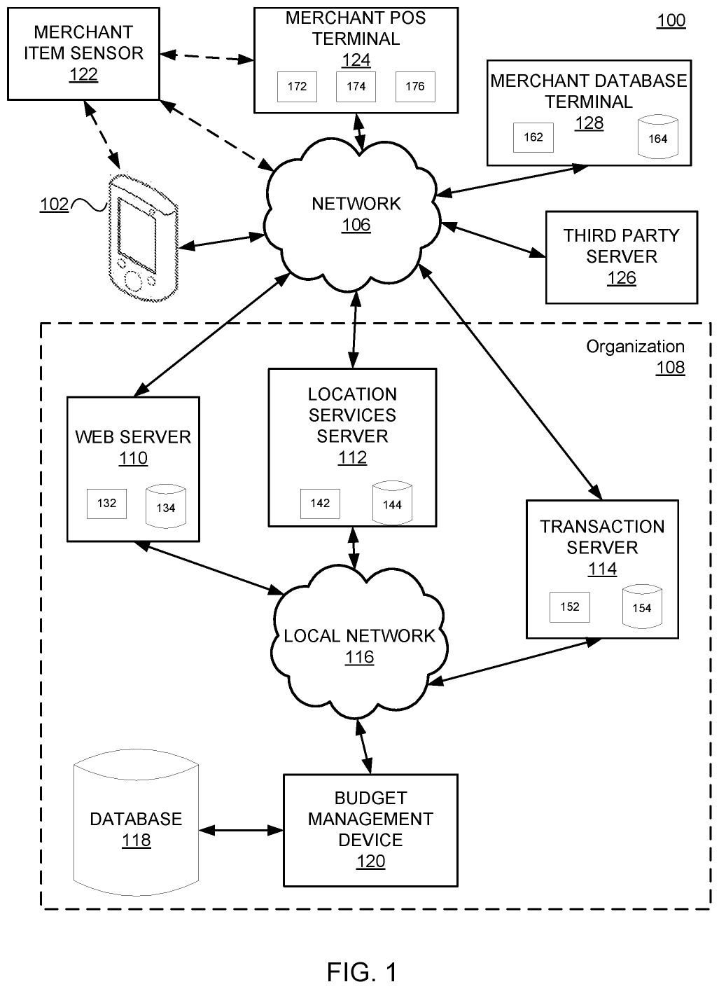

FIG. 1 is a diagram of an exemplary system 100 that may be configured to perform one or more processes that can provide users with the ability to track and monitor their budget in real time. The components and arrangements shown in FIG. 1 are not intended to limit the disclosed embodiments as the components used to implement the disclosed processes and features may vary. As shown, system 100 may include a user device 102, a merchant point of sale (hereinafter “POS”) terminal 124, a merchant item sensor 122, a merchant database terminal 128, a third party server 126, a network 106, and an organization 108 including, for example, a web server 110, a location services server 112, a transaction server 114, a local network 116, a budget management device 120, and a database 118.

In some embodiments, a user may operate user device 102. User device 102 can include a mobile device, smart phone, general purpose computer, tablet computer, laptop computer, telephone, PSTN landline, smart wearable device, voice command device, other mobile computing device, or any other device capable of communicating with network 106 and ultimately communicating with one or more components of organization 108 or with third party server 126. In some embodiments, user device 102 may include or incorporate electronic communication devices for hearing or vision impaired users. User device 102 may belong to or be provide by a user, or may be borrowed, rented, or shared. Users may include individuals such as, for example, subscribers, clients, prospective clients, or users of organization 108, such as individuals who have obtained, will obtain, or may obtain a product, service, or consultation from organization 108. According to some embodiments, user device 102 may include one or more sensors for obtaining biometric data associated with the user, such as a fingerprint scanner, a microphone and/or digital camera, a geographic location sensor for determining the location of the device, an input/output device such as a transceiver for sending and receiving data, a display for displaying digital images, one or more processors including an authentication processor, and a memory in communication with the one or more processors. According to some embodiments, user device 102 may include one or more sensors for obtaining product data associated with a product the user wish to purchase, such as a microphone, a digital camera, a geographic location sensor for determining the location of the device, an input/output device such as a transceiver for sending and receiving data, a display for displaying digital images, one or more processors including an authentication processor, and a memory in communication with the one or more processors.

Network 106 may be of any suitable type, including individual connections via the internet such as cellular or WiFi networks. In some embodiments, network 106 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Network 106 may comprise any type of computer networking arrangement used to exchange data. For example, network 106 may be the Internet, a private data network, virtual private network using a public network, and/or other suitable connection(s) that enables components in system environment 100 to send and receive information between the components of system 100. Network 106 may also include a public switched telephone network (“PSTN”) and/or a wireless network.

Third party server 126 may comprise a computer system associated with an entity other than organization 108 and users that performs one or more functions associated with the individual and organization 108. For example, third party server 126 can comprise a user verification system that allows a user of user device 102 to verify their identity in order to interact with organization 108. In some embodiments, third party server 126 may be used in conjunction with authentication of a user of a mobile application running on user device 102. In some embodiments, third party server 126 may be a server hosted by organization 108. According to some embodiments, third party server 126 may be a server hosted by a party or entity other than organization 108. In some embodiments, third party server 126 may user protocols such as OAuth and OpenIDConnect in order to verify the identity of a user of a mobile application running on user device 102. In some embodiments, for example, third party 126 server may be a server associated with the manufacture of user device 102. Organization 108 may include an entity such as a business, corporation, individual, partnership, or any other entity that provides one or more of goods, services, and consultations to individuals such as users.

Organization 108 may include one or more servers and computer systems for performing one or more functions associated with products and/or services that organization 108 provides. Such servers and computer systems may include, for example, web server 110, location services server 112, budget management device 120, and/or transaction server 114, as well as any other computer systems necessary to accomplish tasks associated with organization 108 or the needs of users.

Web server 110 may include a computer system configured to generate and provide one or more websites accessible to customers, as well as any other individuals involved in organization 108's normal operations. Web server 110 may include a computer system configured to receive communications from user device 102 via for example, a mobile application, a chat program, an instant messaging program, a voice-to-text program, an SMS message, email, or any other type or format of written or electronic communication. Web server 110 may have one or more processors 132 and one or more web server databases 134, which may be any suitable repository of website data. Information stored in web server 110 may be accessed (e.g., retrieved, updated, and added to) via local network 116 and/or network 106 by one or more devices of system 100. According to some embodiments, web server 110 may host websites, data or software applications that user device 102 may access and interact with. For example, web server 110 may provide a website, web portal or software application that allows a user of user device 102 to access or view account information associated with one or more financial accounts of the user. In some embodiments, web server 110 may receive and forward communications or portions of communications between user device 102 and components of system 100, such as location services server 112, transaction server 114, database 118 and/or budget management device 120. According to some embodiments, web server 110 may be configured to transmit data and/or messages from user device 102 to organization 108, via for example, a mobile application that has been downloaded on user device 102.

In some embodiments, web server 110 may track and store event data regarding interactions between user device 102 associated with a user and organization 108. For example, web server 110 may track user interactions such as login requests, login attempts, successful logins, trusted device requests, updates to budget categories, updates to user accounts, and any other types of interaction that may occur between user device 102 and organization 108.

Location services server 112 may include a computer system configured to track the location of user device 102 based on information and data received from user device 102. For example, location services server 112 may receive location data from user device 102, such as global positioning satellite (GPS) data comprising the coordinates of the device, RFID data of associated with known objects and/or locations, or network data such as the identification, location, and/or signal strength of a wireless base station (e.g., Wi-Fi router, cell tower, etc.) connected to user device 102 that may be used to determine the location of user device 102. According to some embodiments, location services server 112 may store geofencing information that represents a designed location or area. As those of skill in the art will appreciate, a geofence may be a virtual geographic boundary that when crossed by user device 102, may trigger system 100 to execute one or more actions. According to some embodiments, the contours of a geofence may be predetermined, for example, location services server 112 may receive one or more predetermined geofences that are associated with respective locations from a third party. For example, location services server 112 may receive data representative of a geofence around a particular store from an organization associated with the store that determined the location of the geofence. In some embodiments, the contours of a geofence may be determined by receiving (e.g., from a user of system 100) the location of a point (e.g., longitude and latitude) and a radius and setting the contours of the geofence to be equal to the location of a circle draw around the point at the specified radius. In some embodiments, a geofence may be specified by a user of system 100 by, for example, drawing the geofencing onto a virtual map or otherwise inputting the location of the geofence.

Location services server 112 may have one or more processors 142 and one or more location services databases 144, which may be any suitable repository of location data. Information stored in location services server 112 may be accessed (e.g., retrieved, updated, and added to) via local network 116 and/or network 106 by one or more devices of system 100. In some embodiments, location services server processor 142 may be used to determine the location of user device 102, whether user device 102 has crossed a particular geofence or whether user device 102 is inside or outside of an area designated by a particular geofence. In some embodiments, location services server 112 may be configured to send messages and/or data to other devices, such as for example, user device 102 or budget management device 120, upon determining that user device 102 has crossed a specified geofence or entered an area encompassed by a specified geofence. For example, in some embodiments, location services server 112 may be configured to trigger system 100 to send to user device 102 a notification that one or more budget categories of the user's budget are associated with the user's current location and may provide, for example, the details of the budget categories, such as the amount of the money remaining in the category, the amount of time remaining in the budget cycle, and other information that may be relevant to the user. According to some embodiments, location services server 112 may receive data representative of a location that is associated with a merchant. For example, budget management device 120 may provide data to location services server 112 representative of a location of a particular store that is associated with a particular budget category. Location services server 112 may generate, receive or access geofence information associated with the received location and may monitor location data associated with the user device 102 to determine when the user device 102 has entered the location. Location services server 112 may determine that user device has entered the location by determining that, for example, user device has crossed over the geofence associated with the merchant location. In this way, location services server 112 may determine when a user has entered a merchant location or proximity to a relevant merchant associated with the user's budget categories. In some embodiments, location services server 112 may continuously (e.g., periodically or regularly) receive the location of user device 102 from a mobile application running on user device 102. For example, in some embodiments, user may have an application running on a user device that continuously sends location data to system. In some example embodiments, location services server 112 may receive the location of user device 102 from a mobile application running on user device 102 upon opening of the application. In some embodiments, a beacon or other similar device may be installed at merchant location, and may transmit a signal that, when received by user device 102, may trigger an application running on user device 102 to transmit the location of user device 102 to location services server 112.

Transaction server 114 may include a computer system configured to process one or more transactions involving a financial account associated with a customer. For example, a transaction may be a purchase of goods or services from a merchant that is made in association with a financial account, such as a bank account or a credit card account. Transactions may be initiated at merchant POS terminal 124 by for example, swiping a credit card or making a payment using financial account information stored on a smartphone in a digital wallet. Such transactions may be made at merchant locations or at a merchant website via the internet. Transactions may be made using for example, a credit card, a debit card, a gift card, or other ways of conveying financial account numbers and/or account credentials that are known in the art. Transaction server 114 may have one or more processors 152 and one or more transaction server databases 154, which may be any suitable repository of transaction data. Information stored in transaction server 114 may be accessed (e.g., retrieved, updated, and added to) via local network 116 and/or network 106 by one or more devices of system 100. According to some embodiments, transaction server 114 may store account numbers, such as primary account numbers (PANs) associated with credit/debit cards or other such financial account numbers, that may be used in transaction monitoring as described in greater detail below. In some embodiments, transaction server 114 may store rules, conditions, restrictions or other such limitations that are associated with a user's budget information and that may be applied to an attempted transaction to determine if the attempted transaction should be authorized or cancelled.

According to some embodiments, transaction server 114 may receive transaction authorization data and/or requests from one or more merchant POS terminals 124 based on an attempted transaction made at a merchant. For example, if a purchaser swipes a credit card at card reader associated with merchant POS terminal 124 or types in a credit card number on a website to make a purchase, merchant POS terminal 124 may generate a transaction authorization request and transmit the transaction authorization request to transaction server 114. Such transaction authorization requests may include data indicative of a financial account (e.g., a PAN or account number) used to make a purchase, a time stamp, and MCC associated with the merchant and/or location at which the attempted purchase was made. According to some embodiments, transaction server 114 may determine whether to authorize a transaction based on the transaction authorization request and any conditions or limitations associated with the user budget information. In some embodiments, the transaction authorization request may include conditions such as an amount of money that can be spent in a given time period on a class of items and a list of merchants associated with the class of items. Thus, in some embodiments, transaction server 114 may identify attempted transactions made based on transaction authorization data, and then may further determine whether the attempted transaction is authorized by applying the associated budget limitations to the data associated with the transaction authentication request. Attempted transactions that satisfy the associated budget limitations may be approved. Attempted transactions that do satisfy the associated budget limitations may require real time approval from the user in order to be approved. Those of skill in the art will understand that real time may mean within a short time period of a trigger in order to allow for a timely response.

In some embodiments, in response to authorizing a transaction, transaction server 114 may store a record of the transaction and update account information such as the balance of the account or the balance remaining in the relevant budget category. Although the preceding description was made with respect to a credit card, it should be understood that other embodiments relating to other types of payment methods such as debit cards, gift cards, and any other such type of financial account, including online financial accounts, are contemplated as well.

According to some embodiments, transaction server 114 may determine the identity of a merchant associated with an attempted transaction based on the merchant category code (“MCC”) included in the transaction authorization data. For example, in some embodiments, transaction server 114 may be configured to determine the identity of the business, such as a particular chain of fast food restaurants, based on the MCC. In some embodiments, transaction server 114 may be configured to determine the location or address of the attempted purchase based on the MCC or other data provided with a transaction authorization request. According to some embodiments, if the identity of the merchant may not be determined solely based on the MCC, it may be determined based on the MCC in conjunction with the location information derived from the transaction authorization request. In some embodiments, transaction server 114 may be configured to determine the type of business at which the attempted transaction is made based on the MCC, such as a restaurant, gas station, book store, movie theater and the like. According to some embodiments, transaction server 114 may be configured to monitor purchases made and attempted within in a specified period of time. For example, transaction server 114 may make specifically record all transactions by a user during a night out and compare to a budget category set up for the night out. For instance, a user may have a budget of $50 designated for Friday night between 8:00 pm and 11:59 pm. In an example embodiment, the user may spend $8 on a beer at 9:00 pm. In such an embodiment, transaction server 114 may send the information for the transaction involving the beer to budget management device 120 and budget management device 120 may apply the transaction to the night out category making the remaining budget $42. By using transaction authorization request data to identify the merchant at which a transaction is attempted and time and date of attempted transaction, system 100 may determine the relevant budget category associated with the attempted purchase and may, in real time, determine whether the purchase is permitted based on the relevant budget parameters.

According to some embodiments, transaction server 114 may be configured to send and/or initiate payments from a financial account in response to authorizing an attempted transaction associated with the account. For example, if transaction server 114 authorizes a particular transaction made using a specified financial account at a merchant, then transaction server 114 may generate an instruction to debit the specified financial account with the amount of the transaction and credit an account associated with the merchant with the same amount. According to some embodiments, if the attempted purchase would cause the user to violate a budget rule, transaction server 114 may require user authorization before initiating payments. For example, if the attempted purchase would cause the user to go over budget for the relevant budget category, system 100 may send a request to the user to authorize or cancel the transaction due to the violation of the budget rule, and transaction server 114 may wait to initiate payment until system 100 receives authorization from the user.

According to some embodiments, transaction server 114 may be configured to send a cancellation message cancelling attempted transaction associated with the account in response to system 100 receiving a cancellation message from the user. According to some embodiments, if the attempted purchase would cause the user to violate a budget rule, transaction server 114 may require user authorization before initiating payments. For example, if the attempted purchase would cause the user to go over budget for the relevant budget category, system 100 may send a request to the user to authorize or cancel the transaction due to the violation of the budget rule, and transaction server 114 may wait to initiate payment until system 100 receives authorization from the user. If the user wishes to cancel the transaction, transaction server 114 may then send a cancellation message instead of initiating payment.

Local network 116 may comprise any type of computer networking arrangement used to exchange data in a localized area, such as WiFi, Bluetooth™ Ethernet, and other suitable network connections that enable components of organization 108 to interact with one another and to connect to network 106 for interacting with components in system environment 100. In some embodiments, local network 116 may comprise an interface for communicating with or linking to network 106. In some embodiments, components of organization 108 may communicate via network 106, without a separate local network 116.

Budget management device 120 may comprise one or more computer systems configured to compile data from a plurality of sources, such as location server 110, communication server 112, and transaction server 114, correlate and analyze the compiled data in real time, arrange the compiled data, generate derived data based on the compiled data, and storing the compiled and derived in a database such as database 118. According to some embodiments, database 118 may be a database associated with organization 108 that stores a variety of information relating to users, transactions, and business operations. Database 118 may also serve as a back-up storage device and may contain data and information that is also stored on, for example, databases 134, 144, 154, 260, 270, and 280. Database 118 may be accessed by budget management device 120 and may be used to store the budget information that is associated with user accounts. Additionally, in some alternate embodiments, database 118 may be accessed by budget management device 120 and may be used to store known biometric data associated with a user.

Merchant database terminal 128 may have one or more processors 162 and one or more merchant databases 164, which may be any suitable repository of merchant data. Merchant database terminal 128 may be located at the POS location, off-site at another merchant location, or at a third-party location. Information stored in merchant database terminal 128 may be accessed (e.g., retrieved, updated, and added to) via network 106 by one or more devices (e.g., transaction server 114) of system 100. In other embodiments, merchant POS terminal 124 may be configured to process online transactions on behalf of the associated merchant. Merchant database 164 may store information relating to products and services offered by merchants such as pricing, quantity, availability, discounts, reviews, and any other such generally available information that a consumer may utilize in making a purchasing decision. In some embodiments, merchant database 164 may also include location information associated with products and services that identifies the location(s) that a particular product or service is available for purchase. In some embodiments, the location information may include an identification of a particular store, terminal, or kiosk that the product or service may be purchased from. According to some embodiments, merchant database 164 may be configured to classify items (e.g., items purchased in a transaction) into budget categories. In some embodiments, merchant database 164 may be configured to split up a single purchase into multiple purchases based on the type of items purchased and the budget categories associated with the items purchased.

Merchant POS terminal 124 may have one or more POS devices 172, 174, 176 that communicate with one or more devices (e.g., user device 102) of system 100 via network 106. In some embodiments, POS devices 172, 174, 176 may be devices that are configured to receive or obtain payment information from user device 102. For example, one or more POS devices 172 174, 176 may include a near-field communication interface, a Bluetooth communication interface, a WiFi communication interface, or any other such communication interface that may enable communication between merchant POS terminal 124 and user device 102. In some embodiments, one or more POS devices 172, 174, 176 may include a scanner for scanning images or data that convey payment information displayed by user device 102, an image capture device for capturing images displayed by user device 102, a card-reading device for obtaining payment information from a card (e.g., by reading a chip embedded in the card or reading information from a magnetic strip), or a keypad for receiving a user input representative of payment information (e.g., a typed credit card number). According to some embodiments, merchant POS terminal 124 may be configured to classify items (e.g., items purchased in a transaction) into one or more budget categories. For example, if a user purchases $100 worth of food and $100 worth of clothing from a single merchant, the merchant POS terminal 124 may categorize the food items as a “food” and classify the clothing items as “clothing.” In some cases, merchant POS terminal 124 may receive budget classification information including the budget category a user has chosen to be associated with an item to be purchased, and split the purchase across budget categories.

Merchant item sensor 122 may comprise any type of sensor for obtaining information associated with one or more items offered for sale by a merchant, such as an RFID tag reader, an optical scanner, a weight sensor, a digital camera, a geographic location sensor, an input/output device such as a transceiver for sending and receiving data. Merchant item sensor 122 may be located at the merchant location. For example, in some embodiments, merchant item sensor 122 may be integrated into shopping carts located at merchant location. Merchant item sensor 122 may be also be a sensor integrated into user device 102. For example, in some embodiments, merchant item sensor 122 may be a digital camera associated with a user device. In such an embodiment, when the user puts an item into their cart, merchant item sensor 122 may capture an image or video of the item and may determine what the item is based on the image or video. In some embodiments, merchant item sensor 122 may capture an image or video of an item's barcode and may determine what the item is based barcode data.

In some embodiments, merchant item sensor 122 may be configured to communicate with compatible devices and ID tags when they are within a predetermined range. Merchant item sensor 122 may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies. For example, in some embodiments, items to be purchased may have an ID tag integrated and merchant item sensor 122 may detect that the item has been placed in the cart. In some embodiments, merchant item sensor 122 may transmit data associated with items to user device 102. For example, in some embodiments, merchant item sensor 122 may capture data relating to items put into a cart and may transmit the data to user device 102 for processing. According to some embodiments, merchant item sensor 122 may transmit data associated with items to merchant POS terminal 124. For example, in some embodiments, merchant item sensor 122 may capture data relating to items that a user places in their cart and may transmit the data to merchant POS terminal 124. As will be appreciated, in such an embodiment, the amount of time required to checkout may be reduced as the items would not have to be scanned by POS device 172, 174, or 176.

Although the preceding description describes various functions of web server 110, location services server 112, transaction server 114, merchant item sensor 122, budget management device 120, third party server 126, database 118, merchant database terminal 128, and merchant POS terminal 124, in some embodiments, some or all of these functions may be carried out by a single computing device.

For ease of discussion, embodiments may be described in connection with real time budget tracking and monitoring, and more particularly for tracking a user's purchases and transmitting a message to the user during the authorization of a purchase that would cause the use to go over budget. It is to be understood, however, that disclosed embodiments may be used in many other contexts. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as machine code (e.g., such as that produced by a compiler) and/or high level code that can be executed by a processor using an interpreter

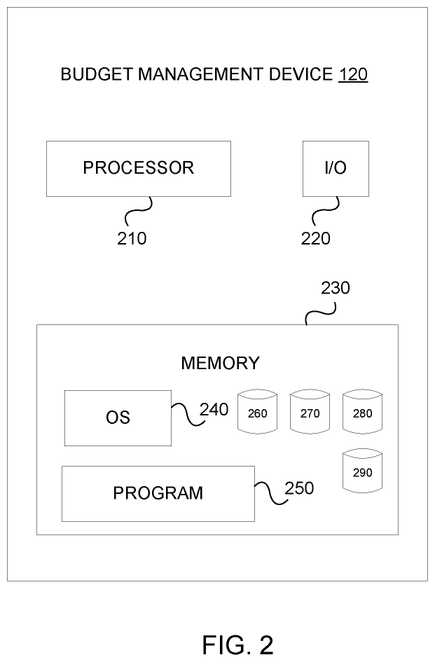

An exemplary embodiment of budget management device 120 is shown in more detail in FIG. 2. User device 102, location server 110, communication server 112, transaction server 114, merchant POS terminal 104, and third party server 126 may have a similar structure and components that are similar to those described with respect to budget management device 120. As shown, budget management device 120 may include a processor 210, an input/output (“I/O”) device 220, a memory 230 containing an operating system (“OS”) 240 and a program 250. For example, budget management device 120 may be a single server or may be configured as a distributed computer system including multiple servers or computers that interoperate to perform one or more of the processes and functionalities associated with the disclosed embodiments. In some embodiments, budget management device 120 may further include a peripheral interface, a transceiver, a mobile network interface in communication with processor 210, a bus configured to facilitate communication between the various components of budget management device 120, and a power source configured to power one or more components of budget management device 120.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee′, ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

Processor 210 may include one or more of a microprocessor, microcontroller, digital signal processor, co-processor or the like or combinations thereof capable of executing stored instructions and operating upon stored data. In some embodiments, processor 210 may be an application or authentication processor that may execute user authentication processes or other processes necessary for running an application associated with the organization 108 on user device 102. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Budget management device 120 may include one or more storage devices configured to store information used by processor 210 (or other components) to perform certain functions related to the disclosed embodiments. In one example budget management device 120 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, budget management device 120 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, budget management device 120 may include memory 230 that may include one or more programs 250 to perform one or more functions of the disclosed embodiments. Moreover, processor 210 may execute one or more programs 250 located remotely from system 100. For example, system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, MySQL databases, Postgres databases, MongoDB databases, in-memory caching solutions such as Redis or Memcached, or other relational or non-relational (e.g., non sql) databases. Memory 230 may include software components that, when executed by processor 210, perform one or more processes consistent with the disclosed embodiments. In some embodiments, memory 230 may include a user account database 260, a user interaction database 270, and a user purchase database 280 for storing related data to enable budget management device 120 to perform one or more of the processes and functionalities associated with the disclosed embodiments.

User account database 260 may include stored data relating to user accounts, such as for example, user identification information (e.g., name, age, sex, birthday, address, VIP status, key user status, preferences, preferred language, vehicle(s) owned, greeting name, channel, talking points (e.g., favorite sports team), etc.), user budget information, bank accounts, mortgage loan accounts, car loan accounts, and other such accounts. User account data stored in user account database 260 may include account numbers, budget categories, budget balances, authorized users associated with one or more accounts, login credentials, known biometric data associated with the user, account balances, account payment history, and other such typical account information. User interaction database 270 may include stored data relating to previous interactions between organization 108 and a user. For example, user interaction database 270 may store user interaction data that includes records of previous budget category data, budget balance data, and other such typical user interaction data. Such data may be used by organization 108 to store patterns (e.g., average amount of money allocated for a given budget category, average amount of budget categories, total amount of money allocated for all budget categories, etc.) of user budgeting that may be used by the organization to educate the user on budgeting insights and make suggestions to users to help them meet identified financial goals. User interaction data may also include information about business transactions between organization 108 and a user. User purchase database 280 may include stored data relating to previous purchase and purchase attempts made by a user. For example, user purchase database 270 may store user interaction data that includes records of previous purchase data, previous budget category data, budget balance data, and other such typical user interaction data. Such data may be used by organization 108 to store patterns (e.g., average amount of money allocated for a given budget category that is spent, percentage of money allocated for a given budget category that is spent, typical stores shopped at within a given budget category, etc.) of user budgeting and purchasing that may be used by the organization to educate the user on budgeting insights and make suggestions to users to help them meet identified financial goals. Although databases 260, 270, 280 have been described as being separate databases for the purposes of the present discussion, these databases may alternately be combined into one or more databases.

Budget management device 120 may also be communicatively connected to one or more memory devices (e.g., databases (not shown)) locally or through a network. The remote memory devices may be configured to store information and may be accessed and/or managed by budget management device 120. By way of example, the remote memory devices may be document management systems, Microsoft™ SQL databases, SharePoint™ databases, Oracle™ databases, Sybase™ databases, MySQL databases, Postgres databases, MongoDB databases, in-memory caching solutions such as Redis or Memcached, or other relational or non-relational (e.g., non sql) databases. Systems and methods consistent with disclosed embodiments, however, are not limited to separate databases or even to the use of a database.

Budget management device 120 may also include one or more I/O devices 220 that may comprise one or more interfaces for receiving signals or input from devices and providing signals or output to one or more devices that allow data to be received and/or transmitted by budget management device 120. In exemplary embodiments of the disclosed technology, budget management device 120 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While budget management device 120 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the budget management device 120 may include a greater or lesser number of components than those illustrated.

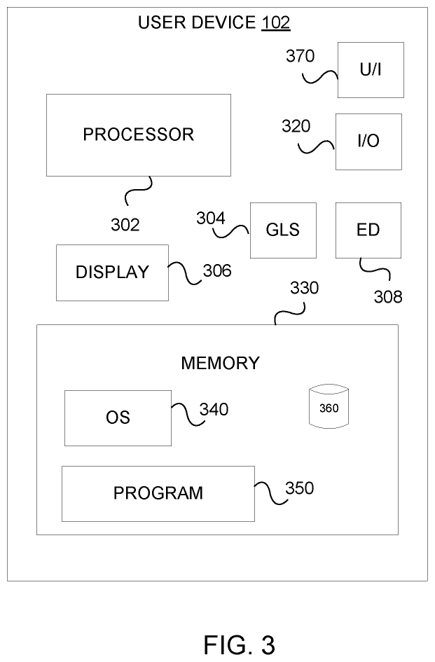

FIG. 3 shows an exemplary interactive embodiment of user device 102. As shown, user device 102 may include an input/output (“I/O”) device 320, a memory 330 containing an operating system (“OS”) 340, a program 350, a database 360, and all associated components as described above with respect to budget management device 120. User device 102 may also include an budget management processor 302 for determining remaining budget balances and comparing purchase data to budget data during authorization; a geographic location sensor (“GLS”) 304 for determining the geographic location of user device 102; a display 306 for displaying digital images or video; a user interface (“U/I”) device 370 for receiving user input data, such as data representative of a click, a scroll, a tap, a press, or typing on an input device that can detect tactile inputs; and an environmental data (“ED”) sensor 308 for detecting biometric data, item data, and/or purchase data. In some embodiments, an environmental data sensor 308 may include, for example but not limited to an RFID reader, NFC transceiver, a fingerprint scanner, an eye or retina scanner, a voice recorder, a microphone, and/or a digital camera. In some embodiments, user device 102 may include one or more processors. According to some embodiments, budget management processor 302 may include all of the features and functions of processor 210 described above.

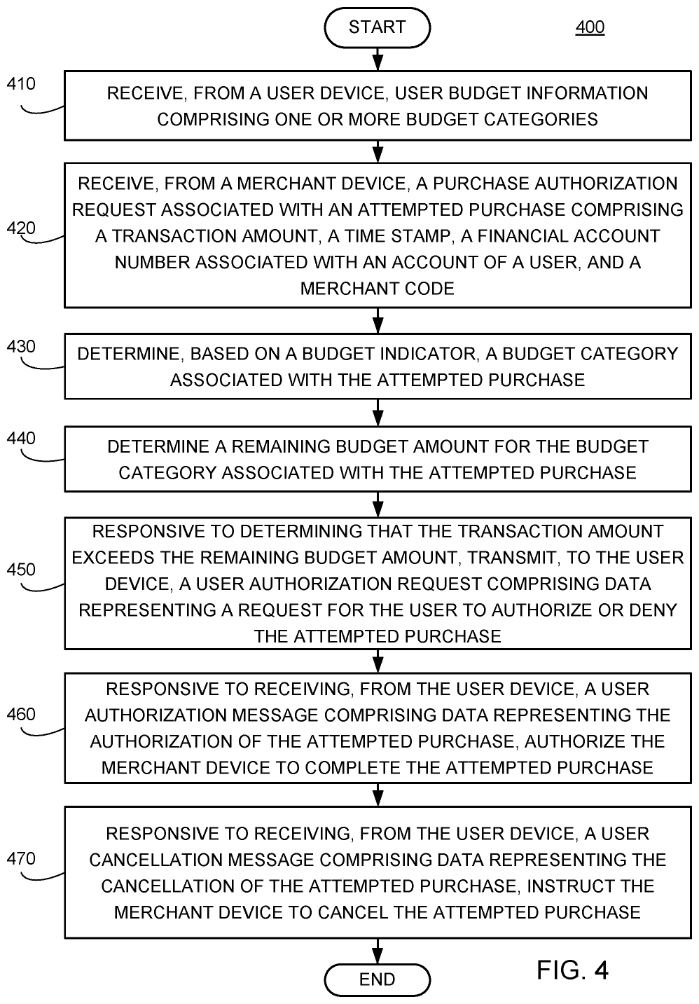

FIG. 4 shows a flowchart of method 400 for providing real time digital budget tracking using POS interaction. Method 400 may be performed by budget management device 120 using processor 210 to execute memory 230. In some embodiments, steps of method 400 may be performed by other elements in system 100, such as user device 102, third party server 126, merchant POS terminal 104, merchant item sensor 122, location server 110, communication server 112, or transaction server 114. Following method 400, the system, by budget management device 120, for example, may transmit a user authorization request, which in some embodiments may include a request for the user to authorize or cancel the attempted purchase. The system may transmit the request to the user, for example, by communication server 112 and to user device 102, and may cancel or authorize the purchase according to the response received from the user, for example, by user device 102.

In block 410, organization 108 may receive from user device 102 user budget information. In some embodiments, user budget information may comprise one or more budget categories and an amount of money allocated to each budget category. According to some embodiments, user budget information may comprise data indicative of a maximum expenditure over a predetermined time period for items associated with the one or more budget category defined by the user. For example, in some embodiments, web server 110 may receive user budget information through network 106 from a user that inputs user budget information in a software application running on user device 102. According to some embodiments, budget category may be based on a specified merchant or type of merchant. For example, in some embodiments, a user may stipulate a specific amount of money budgeted for groceries. In some embodiments, a user may stipulate a specific amount of money budgeted to be spent at Walmart. According to some embodiments, budget category may be based on a specified location or event. For example, in some embodiments, a user may stipulate a specific amount of money budgeted on a specific day or time of day. For instance, a user may stipulate a specific amount that may be spent on all events (e.g., dinner, movie, visit to a bar, etc.) participated in on a night out. In some embodiments, a user may stipulate a specific amount of money budged for a vacation that will be in a different location for a set number of days. After receiving the user budget information, Web server 110 may determine the contents of the user budget information and may forward the user budget information to budget management device 120 through local network 116. In some embodiments, budget management device 120 may receive user budget information through network 106 from a user that selects an option in an application running on user device 102. According to some embodiments, budget management device 120 may subsequently determine the contents of the request. In some embodiments, the communication channel between the software application running on user device 102 and organization 108 may be encrypted using standard protocols such as TLS, TCP, SSH, or other appropriate protocols. In some embodiments, the communication channel between the software application running on user device 102 and organization 108 may be encrypted using application or organization specific protocols specifically developed for the organization.

In block 420, organization 108 may receive a purchase authorization request from a merchant device 172, 174, or 176. In some embodiments, a purchase authorization request may comprise a transaction amount, a time stamp, financial account number associated with an account of a user, and/or a MCC. According to some embodiments, purchase authorization request may comprise stock keeping unit data associated with one or more items. For example, in some embodiments, transaction server 114 may receive a purchase authorization request through network 106 from a user that attempts to complete a purchase on merchant device 172, 174, or 176. Transaction server 114 may determine the contents of the request and forward the request to budget management device 120 through local network 116. In some embodiments, budget management device 120 may receive a purchase authorization request through network 106 from a user that attempts to complete a purchase on merchant device 172, 174, or 176. In some embodiments, a communication channel between a software application running on user device 102 and organization 108 may be encrypted using standard protocols such as TLS, TCP, SSH, or other appropriate protocols. In some embodiments, a communication channel between a software application running on user device 102 and organization 108 may be encrypted using application or organization specific protocols specifically developed for the organization.

In block 430, the system may determine, based on a budget indicator, a budget category associated with the attempted purchase. According to some embodiments, the budget indicator may be the MCC associated with the attempted transaction. In some embodiments, the budget indicator may be the time stamp associated with the attempted transaction. For example, in some embodiments, budget management device 120 may determine a budget category associated with the attempted purchase based on portions or all of the purchase authorization data received in block 420.

In block 440, the system may determine a remaining budget amount for the budget category associated with the attempted purchase. According to some embodiments, the remaining budget amount may comprise data indicative of the remaining expenditure over a predetermined time period for the budget category associated with the attempted purchase. For example, in some embodiments, budget management device 120 may determine a remaining budget amount for the budget category associated with the attempted purchase based on user budget information received in block 410 and based on transaction data received from transaction server 114.

In block 450, responsive to determining that the transaction amount exceeds the remaining budget amount, the system may transmit, to user device 102, a user authorization request comprising data representing a request for the user to authorize or deny the attempted purchase. In some embodiments, user authorization request may be a text message, push notification, or other suitable messaging technology. For example, in some embodiments, budget management device 120 may compare transaction amount to the remaining budget amount and responsive to determining that the transaction amount exceeds the remaining budget amount, budget management device 120 may generate the user authorization request. Further, in some embodiments, budget management device 120 may send the user authorization request to web server 110 via network 116. Web server 110 may then transmit the user authorization request to user device 102. In some embodiments, a communication channel between a software application running on user device 102 and organization 108 may be encrypted using standard protocols such as TLS, TCP, SSH, or other appropriate protocols. In some embodiments, a communication channel between a software application running on user device 102 and organization 108 may be encrypted using application or organization specific protocols specifically developed for the organization.

In block 460, responsive to receiving, from user device 102, a user authorization message comprising data representing the authorization of the attempted purchase, the system may authorize merchant device 172, 174, or 176 to complete the attempted purchase. For example, in some embodiments, web server 110 may receive user authorization message through network 106. Further, in some embodiments, web server 110 may determine the contents of the user authorization message and send the user authorization message to budget management device. In some embodiments, the system, for instance, via budget management device 120, may generate an authorization message indicating that the merchant should authorize the attempted purchase and system may transmit the authorization message to merchant device 172, 174, or 176. In some embodiments, user authorization message may be a text message, push notification, or other suitable messaging technology. In some embodiments, system may receive, from the user device 102, data representing an indication that the identity of the user of user device 102 has been verified by user device 102 in association with the attempted purchase. According to some embodiments, system may receive, from user device 102, data representing an indication that the user intends to authorize the attempted purchase. Further, system may receive, from user device 102, biometric data associated with the user of user device 102. For example, in some embodiments, user device 102 may be equipped with a fingerprint scanner and user may scan fingerprint via fingerprint scanner of user device 102. After receiving the biometric data, the system may authenticate the user of user device 102 by comparing the received biometric data to stored biometric data. For example, in some embodiments, the system may compare the biometric data associated with the user of user device 102 to the stored biometric data, wherein the stored biometric data comprises biometric data associated with an individual associated with the financial account associated with the attempted purchase. In such an embodiment, the system may further determine that the biometric data matches, within a predetermined confidence level, the known biometric data.

In block 470, responsive to receiving, from user device 102, a user cancellation message comprising data representing the cancellation of the attempted purchase, instruct merchant device 172, 174, or 176 to cancel the attempted purchase. For example, in some embodiments, web server 110 may receive user cancellation message through network 106. Further, in some embodiments, web server 110 may determine the contents of the user cancellation message and send the user authorization message to budget management device. In some embodiments, the system, for instance, via budget management device 120, may generate a cancellation message indicating that the merchant should cancel the attempted purchase and system may transmit the cancellation message to merchant device 172, 174, or 176. In some embodiments, user cancellation message may be a text message, push notification, or other suitable messaging technology.

Method 400 may also comprise embodiments where the system may receive, from user device potential purchase data representing an item selected by the user. For example, in some embodiments, transaction server 114 may receive potential purchase data from merchant item sensor 122 and through network 106. In some embodiment, merchant item sensor 122 may obtain potential purchase data by detecting a beacon, scanning a barcode, scanning a QR code, or capturing an image of the selected item. According to some embodiments, merchant item sensor 122 may be integrated into user device 102. In some embodiments, merchant item sensor 122 may be integrated into a shopping cart. In some embodiments, potential purchase data may include stock keeping unit data associated with one or more items. After receiving potential purchase data, system may determine a budget category associated with the potential purchase data. According to some embodiments, system may determine a budget category based on stock keeping unit data. For example, in some embodiments, budget management device 120 may determine a budget category associated with the potential purchased data based on all or portions of the previously received potential purchase data. Further, system may determine a provisional budget amount for the budget category associated with the potential purchase data. In some embodiments, the provisional budget amount may be an amount that would be left in the budget category associated with the potential purchase data were the user to purchase the selected item. For example, budget management device 120 may determine a remaining budget amount for the budget category associated with the potential purchase data based on user budget information received in block 410 and based on transaction data received from transaction server 114. Next, budget management device 120 may determine the provisional budget amount by subtracting the cost of the item selected by the user from the remaining budget amount. Responsive to determining that the provisional budget amount is less than zero, the system may generate a warning message indicating that authorizing the purchase of the item selected by the user would cause the budged category associated with the potential purchase data to be exceeded. For example, budget management device 120 may determine that the provisional budget amount is less than zero and may generate a warning message and send the warning message through network 116 to web server 110. The system may then transmit the warning message to user device 102. For example, web server 110 may package the warning message and may transmit the warning message through network 106 to user device 102.

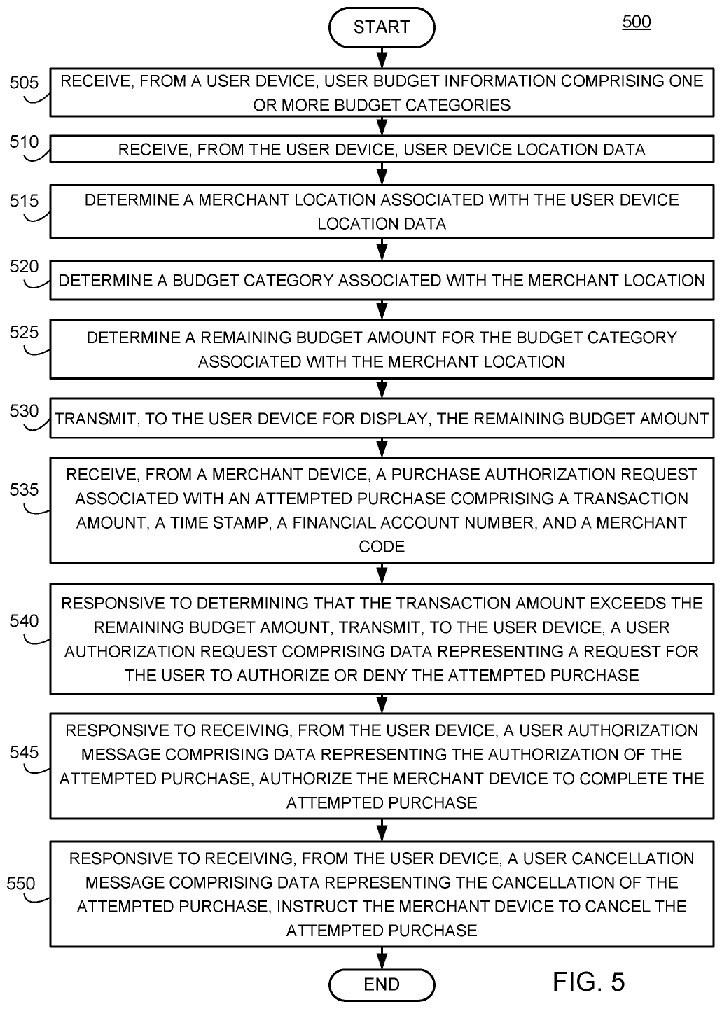

FIG. 5 shows a flowchart of a method 500 for providing real time digital budget tracking using device location data and POS interaction. Method 500 may be performed by budget management device 120 using processor 210 to execute memory 230. In some embodiments, steps of method 500 may be performed by other elements in system 100, such as user device 102, third party server 126, merchant POS terminal 104, merchant item sensor 122, location server 110, communication server 112, or transaction server 114. Following method 500, the system, by budget management device 120, for example, may transmit a remaining budget amount for a relevant budget category of a merchant associated with the location of the user device. Further, the system, by budget management device 120, for example, may transmit a user authorization request, which in some embodiments may include a request for the user to authorize or cancel the attempted purchase. The system may transmit the request to the user, for example, by communication server 112 and to user device 102, and may cancel or authorize the purchase according to the response received from the user, for example, by user device 102.

In block 505, organization 108 may receive from user device 102 user budget information. In some embodiments, user budget information may comprise one or more budget categories and an amount of money allocated to each budget category. According to some embodiments, user budget information may comprise data indicative of a maximum expenditure over a predetermined time period for items associated with the one or more budget category defined by the user. For example, in some embodiments, web server 110 may receive user budget information through network 106 from a user that inputs user budget information in a software application running on user device 102. According to some embodiments, budget category may be based on a specified merchant or type of merchant. For example, in some embodiments, a user may stipulate a specific amount of money budgeted for groceries. In some embodiments, a user may stipulate a specific amount of money budgeted to be spent at Walmart. According to some embodiments, budget category may be based on a specified location or event. For example, in some embodiments, a user may stipulate a specific amount of money budgeted on a specific day or time of day. For instance, a user may stipulate a specific amount that may be spent on all events (e.g., dinner, movie, visit to a bar, etc.) participated in on a night out. In some embodiments, a user may stipulate a specific amount of money budged for a vacation that will be in a different location for a set number of days. After receiving the user budget information, Web server 110 may determine the contents of the user budget information and may forward the user budget information to budget management device 120 through local network 116. In some embodiments, budget management device 120 may receive user budget information through network 106 from a user that selects an option in an application running on user device 102. According to some embodiments, budget management device 120 may subsequently determine the contents of the request. In some embodiments, the communication channel between the software application running on user device 102 and organization 108 may be encrypted using standard protocols such as TLS, TCP, SSH, or other appropriate protocols. In some embodiments, the communication channel between the software application running on user device 102 and organization 108 may be encrypted using application or organization specific protocols specifically developed for the organization.

In block 510, the system may receive, from user device 102, user device location data. For example, in some embodiments, location services server 112 may receive location data through network 106 from user device 102. According to some embodiments, user device location data may include global positioning satellite (GPS) data received from user device 102. In some embodiments, user device location data may include wireless access point connection information associated with user device 102. According to some embodiments, the wireless access point connection information may include locations of one or more wireless access points. In some embodiments, user device location data may include visual information obtained from an image capture device associated with user device 102.

In block 515, the system may determine a merchant location based on the user device location data. In some embodiments, for example, location services server 112 may determine that the location of user device 102 is associated with a merchant. In some embodiments, determining that user device 102 has entered a merchant location may include identifying a visual marker by performing image recognition techniques on the visual information and determining that the visual marker is associated with the merchant location. According to some example embodiments, location services server 112 may determine that the location of user device 102 is within a geofenced are associated with a merchant location. In some embodiments, cation services server 112 may determine the approximate position of user device 102 based on the locations of the one or more wireless access points and may subsequently determine that the approximate position of user device 102 corresponds to a merchant location.

In block 520, the system may determine a budget category associated with the merchant location. For example, in some embodiments, budget management device 120 may determine a budget category associated with the merchant location.

In block 525, the system may determine a remaining budget amount for the budget category associated with the merchant location. According to some embodiments, the remaining budget amount may comprise data indicative of the remaining expenditure over a predetermined time period for the budget category associated with the merchant location. For example, in some embodiments, budget management device 120 may determine a remaining budget amount for the budget category associated with the merchant location based on user budget information received in block 505 and based on transaction data received from transaction server 114.

In block 530, the system may transmit, to user device 102 for display, the remaining budget amount. For example, in some embodiments, budget management device 102 may send remaining budget amount data through network 116 to web server 110. Web server 110 may transmit remaining budget amount data configured to be displayed on display 306 of user device 102 through network 106 to user device 102.

In block 535, organization 108 may receive a purchase authorization request from a merchant device 172, 174, or 176. In some embodiments, a purchase authorization request may comprise a transaction amount, a time stamp, financial account number associated with an account of a user, and/or a MCC. According to some embodiments, purchase authorization request may comprise stock keeping unit data associated with one or more items. For example, in some embodiments, transaction server 114 may receive a purchase authorization request through network 106 from a user that attempts to complete a purchase on merchant device 172, 174, or 176. Transaction server 114 may determine the contents of the request and forward the request to budget management device 120 through local network 116. In some embodiments, budget management device 120 may receive a purchase authorization request through network 106 from a user that attempts to complete a purchase on merchant device 172, 174, or 176. In some embodiments, a communication channel between a software application running on user device 102 and organization 108 may be encrypted using standard protocols such as TLS, TCP, SSH, or other appropriate protocols. In some embodiments, a communication channel between a software application running on user device 102 and organization 108 may be encrypted using application or organization specific protocols specifically developed for the organization.

In block 540, responsive to determining that the transaction amount exceeds the remaining budget amount, the system may transmit, to user device 102, a user authorization request comprising data representing a request for the user to authorize or deny the attempted purchase. In some embodiments, user authorization request may be a text message, push notification, or other suitable messaging technology. For example, in some embodiments, budget management device 120 may compare transaction amount to the remaining budget amount and responsive to determining that the transaction amount exceeds the remaining budget amount, budget management device 120 may generate the user authorization request. Further, in some embodiments, budget management device 120 may send the user authorization request to web server 110 via network 116. Web server 110 may transmit the user authorization request to user device 102. In some embodiments, a communication channel between a software application running on user device 102 and organization 108 may be encrypted using standard protocols such as TLS, TCP, SSH, or other appropriate protocols. In some embodiments, a communication channel between a software application running on user device 102 and organization 108 may be encrypted using application or organization specific protocols specifically developed for the organization.

In block 545, responsive to receiving, from user device 102, a user authorization message comprising data representing the authorization of the attempted purchase, the system may authorize merchant device 172, 174, or 176 to complete the attempted purchase. For example, in some embodiments, web server 110 may receive user authorization message through network 106. Further, in some embodiments, web server 110 may determine the contents of the user authorization message and send the user authorization message to budget management device. In some embodiments, the system, for instance, via budget management device 120, may generate an authorization message indicating that the merchant should authorize the attempted purchase and system may transmit the authorization message to merchant device 172, 174, or 176. In some embodiments, user authorization message may be a text message, push notification, or other suitable messaging technology. In some embodiments, system may receive, from the user device 102, data representing an indication that the identity of the user of user device 102 has been verified by user device 102 in association with the attempted purchase. According to some embodiments, system may receive, from user device 102, data representing an indication that the user intends to authorize the attempted purchase. Further, system may receive, from user device 102, biometric data associated with the user of user device 102. After receiving the biometric data, the system may authenticate the user of user device 102 by comparing the received biometric data to stored biometric data. For example, in some embodiments, the system may compare the biometric data associated with the user of user device 102 to the stored biometric data, wherein the stored biometric data comprises biometric data associated with an individual associated with the financial account associated with the attempted purchase. In such an embodiment, the system may further determine that the biometric data matches, within a predetermined confidence level, the known biometric data.

In block 550, responsive to receiving, from user device 102, a user cancellation message comprising data representing the cancellation of the attempted purchase, instruct merchant device 172, 174, or 176 to cancel the attempted purchase. For example, in some embodiments, web server 110 may receive user cancellation message through network 106. Further, in some embodiments, web server 110 may determine the contents of the user cancellation message and send the user authorization message to budget management device. In some embodiments, the system, for instance, via budget management device 120, may generate a cancellation message indicating that the merchant should cancel the attempted purchase and system may transmit the cancellation message to merchant device 172, 174, or 176. In some embodiments, user cancellation message may be a text message, push notification, or other suitable messaging technology.

Method 500 may also comprise embodiments where the system may receive, from user device potential purchase data representing an item selected by the user. For example, in some embodiments, transaction server 114 may receive potential purchase data from merchant item sensor 122 and through network 106. In some embodiment, merchant item sensor 122 may obtain potential purchase data by detecting a beacon, scanning a barcode, scanning a QR code, or capturing an image of the selected item. According to some embodiments, merchant item sensor 122 may be integrated into user device 102. In some embodiments, merchant item sensor 122 may be integrated into a shopping cart. In some embodiments, potential purchase data may include stock keeping unit data associated with one or more items. After receiving potential purchase data, system may determine a budget category associated with the potential purchase data. According to some embodiments, system may determine a budget category based on stock keeping unit data. For example, in some embodiments, budget management device 120 may determine a budget category associated with the potential purchased data based on all or portions of the previously received potential purchase data.

According to some embodiments, a user may designate a budget category associated with the potential purchase data. For example, in some embodiments, after receiving potential purchase data (e.g., via merchant item sensor 122), system may prompt user (e.g., via user device 102) to designate a budget category associated with the potential purchase data (e.g., each of a plurality of items represented in the potential purchase data). In some embodiments, the system may prompt the user as the potential purchase data is received (e.g., as each item is scanned the merchant item sensor 122). According to some embodiments, the system may prompt the user when a purchase authorization request is received.

In some implementations, the system may determine a provisional budget amount for the budget category associated with the potential purchase data. In some embodiments, the provisional budget amount may be an amount that would be left in the budget category associated with the potential purchase data were the user to purchase the selected item. For example, budget management device 120 may determine a remaining budget amount for the budget category associated with the potential purchase data based on user budget information received in block 505 and based on transaction data received from transaction server 114. Next, budget management device 120 may determine the provisional budget amount by subtracting the cost of the item selected by the user from the remaining budget amount. Responsive to determining that the provisional budget amount is less than zero, the system may generate a warning message indicating that authorizing the purchase of the item selected by the user would cause the budged category associated with the potential purchase data to be exceeded. For example, budget management device 120 may determine that the provisional budget amount is less than zero and may generate a warning message and send the warning message through network 116 to web server 110. The system may then transmit the warning message to user device 102. For example, web server 110 may package the warning message and may transmit the warning message through network 106 to user device 102.

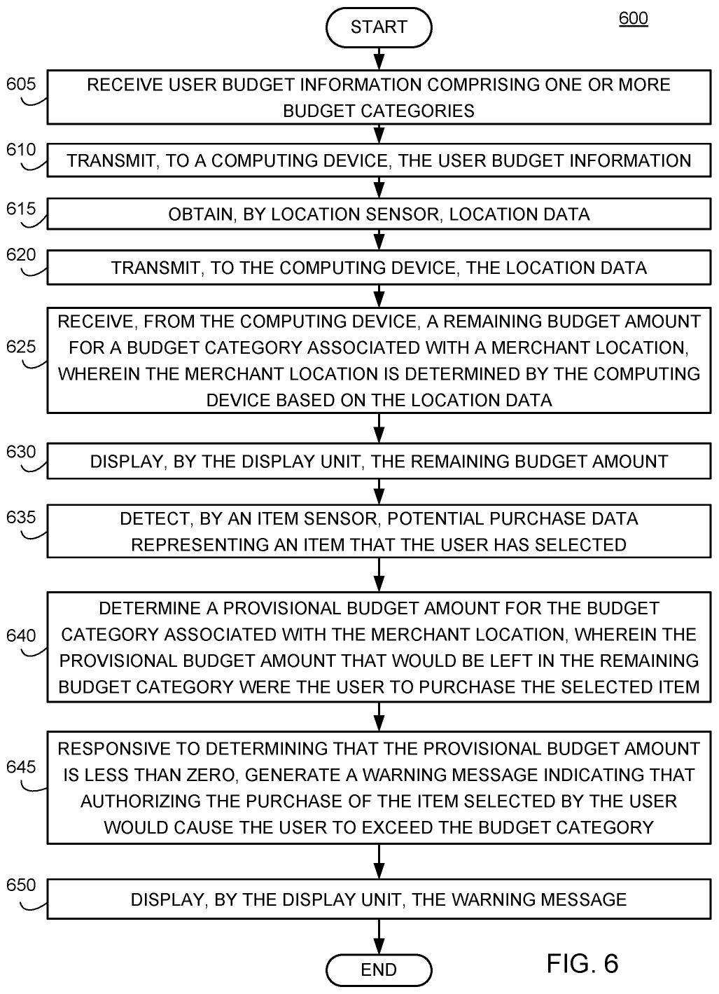

FIG. 6 shows a flowchart of a method 600 for providing real time digital budget tracking using device location data and POS interaction. Method 600 may be performed by user device 102 using processor 302 to execute memory 330. In some embodiments, steps of method 400 may be performed by other elements in system 100, such as user device 102, third party server 126, merchant POS terminal 104, merchant item sensor 122, location server 110, communication server 112, or transaction server 114. Following method 600, the system may detect an item to be purchased, for example, by merchant item sensor 122, and may determine a provisional budget amount for a budget category associated with the item to be purchased. If system 600 determines that the provisional budget amount is less than zero, then the system may generate, for example by budget management processor 302, a warning message and may display, for example by display 306, error message.

In block 605, system may receive user budget information. In some embodiments, user budget information may comprise one or more budget categories and an amount of money allocated to each budget category. According to some embodiments, user budget information may comprise data indicative of a maximum expenditure over a predetermined time period for items associated with the one or more budget category defined by the user. For example, in some embodiments, user device 102 may receive user budget information from a user that inputs user budget information in a software application running on user device 102. According to some embodiments, budget category may be based on a specified merchant or type of merchant. For example, in some embodiments, a user may stipulate a specific amount of money budgeted for groceries. In some embodiments, a user may stipulate a specific amount of money budgeted to be spent at a specific store or a chain of stores. According to some embodiments, budget category may be based on a specified location or event. For example, in some embodiments, a user may stipulate a specific amount of money budgeted on a specific day or time of day. For instance, a user may stipulate a specific amount that may be spent on all events (e.g., dinner, movie, visit to a bar, etc.) participated in on a night out. In some embodiments, a user may stipulate a specific amount of money budged for a vacation that will be in a different location for a set number of days.

In block 610, the system (e.g., budget management device 120) may transmit, to a computing device, the user budget information. For example, in some embodiments, user device 102 may transmit through network 106 and to web server 110, the user budget information. In some embodiments, the communication channel between the software application running on user device 102 and organization 108 may be encrypted using standard protocols such as TLS, TCP, SSH, or other appropriate protocols. In some embodiments, the communication channel between the software application running on user device 102 and organization 108 may be encrypted using application or organization specific protocols specifically developed for the organization

In block 615, system (e.g., location services server 112) may obtain, by a location sensor associated with user device 102, user device location data. According to some embodiments, user device location data may include global positioning satellite (GPS) data received from user device 102. In some embodiments, user device location data may include wireless access point connection information associated with user device 102. According to some embodiments, the wireless access point connection information may include locations of one or more wireless access points. In some embodiments, user device location data may include visual information obtained from an image capture device associated with user device 102.

In block 620, the system (e.g., communication server 110) may transmit, to a computing device, the user device location data. For example, in some embodiments, user device 102 may transmit through network 106 and to web server 110, the user device location data. In some embodiments, the communication channel between the software application running on user device 102 and organization 108 may be encrypted using standard protocols such as TLS, TCP, SSH, or other appropriate protocols. In some embodiments, the communication channel between the software application running on user device 102 and organization 108 may be encrypted using application or organization specific protocols specifically developed for the organization

In block 625, the system may receive, from the computing device, a remaining budget amount for a budget category associated with a merchant location, wherein the merchant location is determined by the computing device based on the location data. For example, in some embodiments, user device 102 may receive through network 106 data representing the remaining budget amount for a budget category associated with a merchant location.

In block 630, the system may display, by the display unit, the remaining budget amount. For example, in some embodiments, user device 102 may, by processor 302, transfer the data representing remaining budget amount from I/O 220 to display 306. In some embodiments, display 306 may be a screen associated with user device 102, such as for example a screen of a mobile phone, tablet, or other mobile computing device.

In block 635, the system may detect, by an item sensor, potential purchase data representing an item that the user has selected. For example, in some embodiments, use device 102 may receive potential purchase data from merchant item sensor 122. In some embodiments, merchant item sensor 122 may obtain potential purchase data by detecting a beacon, scanning a barcode, scanning a QR code, or capturing an image of the selected item. According to some embodiments, merchant item sensor 122 may be integrated into user device 102. In some embodiments, merchant item sensor 122 may be integrated into a shopping cart. In some embodiments, potential purchase data may include stock keeping unit data associated with one or more items.

In block 640, the system may determine a provisional budget amount for the budget category associated with the merchant location, wherein the provisional budget amount that would be left in the remaining budget category were the user to purchase the selected item. According to some embodiments, the provisional budget amount may comprise data indicative of the remaining expenditure over a predetermined time period for the budget category associated with the merchant location. For example, in some embodiments, user device 102 may determine a provisional budget amount for the budget category associated with the merchant location based on the remaining budget amount received in block 625 and based on the potential purchase data detected in block 635. According to some example embodiments, the provisional budget amount may be the result of subtracting cost associated with the potential purchase data from the remaining budget amount.

In block 645, responsive to determining that the provisional budget amount is less than zero, the system may generate a warning message indicating that authorizing the purchase of the item selected by the user would cause the user to exceed the budget category. In some embodiments, warning message may be a push notification or other suitable messaging technology. For example, in some embodiments, responsive to determining that the provisional budget amount is less than zero, user device 102 may generate a warning message.

In block 650, the system may display, by the display unit, the warning message. For example, in some embodiments, user device 102 may, by processor 302, transfer the data representing warning message from I/O 220 to display 306. In some embodiments, display 306 may be a screen associated with user device 102, such as for example a screen of a mobile phone, tablet, or other mobile computing device.

Method 600 may also comprise embodiments where the system may receive, from computing device, a user authorization request comprising data representing a request for the user to authorize or deny the attempted purchase. For example, in some embodiments, user device 102 may receive through network 106 and from organization 108, a user authorization request. Further, in some embodiments, responsive to receiving, from a sensor, authorization data representing the authorization of the attempted purchase, the system may transmit, to the computing device, the authorization data. Additionally, in some embodiments, responsive to receiving, from a sensor, cancellation data representing the cancellation of the attempted purchase, the system may transmit, to the computing device, the cancellation data. For example, in some embodiments, user may select an option displayed on display 306 of user device 102. In some embodiments, user may orient user device 102 in such a way that a sensor associated with user device 102 may interpret the orientation as a user repose. Further in some embodiments, the system may obtain, by a sensor, data representing the user's intent to authorize the attempted purchase. In some embodiments, the system may obtain, by a sensor, biometric data associated with the user. After obtaining the biometric data, the system may authenticate the user by comparing the received biometric data to stored biometric data.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Exemplary Use Cases

The following exemplary use case describes one example of a typical user flow pattern. It is intended solely for explanatory purposes and not in limitation. A user may desire to track and monitor a budget in real time and manage spending through budget regulated point of sale alerts. A user may enter (e.g., via user device 102) budget information (e.g., budget categories and maximum expenditures in said categories) associated with the user's account. For example, the user may go to a web site associated with the organization and enter their budget information. Once the budget information is entered, the user is able to track spending. Upon initiating a purchase, the system may receive (e.g., via transaction server 114) a request to authorize the purchase from a merchant device (e.g. via merchant POS terminal 124). The system may determine (e.g., via budget management device 120) a budget category from the user budget information that the purchase relates to. The system may determine the budget category based upon the type of merchant. For instance, purchases at a grocery store may fall into the grocery budget category. The system may determine the budget category based upon the location of the transaction(s). For example, a user may set a budget category for all purchases made while on vacation in Florida. In such an example, system may determine the user's location based on transaction data from an initiated purchase. In other such examples, system may determine the user's location based on location data from a device associated with the user. The system may also determine the budget category based upon the time of the transaction(s). For example, a user may set a budget category for all purchases made between 8:00 pm and 11:59 pm on a Friday night. In such an example, system may determine the time a transaction is initiated based on transaction data from an initiated purchase. In other such examples, system may determine the time a transaction is initiated based on when system receives notice of the initiated transaction. The system may also determine the budget category based upon the type of item. According to some examples, purchases of fruit, such as a banana, may fall into the grocery budget category. In such examples, it may be possible that items within a single transaction may fall within more than one budget category (e.g., buy a banana, which falls into a grocery budget category and also buy a shirt, which falls into a clothing budget category). After determining the relevant budget category, the system may determine (e.g., via budget management device) the remaining budget amount for that category. Further, the system may determine whether the transaction amount exceeds the determined remaining budget amount. For example, if the transaction amount equals or is less than the remaining budget amount, the system may authorize the purchase. If the transaction amount is determined to exceed the remaining budget amount, the system may send a request for the user to authorize or deny the purchase (e.g., to user device 102). The user may then select whether to approve or deny the purchase (e.g., via selecting an option on user device 102). If the user chooses to complete the purchase, the system will authorize the purchase. If the user chooses to deny the purchase, the system will instruct the merchant device to cancel the purchase.

An additional use case where a user may desire to have the ability to track their budget in real time using geographic budget alerts in addition to the point of sale warning messages is presented. As with the prior use case, the following exemplary use case describes one example of a typical user flow pattern. It is intended solely for explanatory purposes and not in limitation. The user may enter budget information as previously discussed. Once the budget information is entered, the user may go shopping. Upon entering a merchant location, the system may receive the users location (e.g., via user device 102) and may determine a relevant budget category associated with the merchant at that location. For example, user may have an application running on a user device that continuously, periodically, or regularly sends location data to system. For example, the application may send location data to the system in response to the location of the user device changing by a distance greater that a threshold. In some examples, user may open application running on a user device in order to send location data to system. In some examples, a beacon or other similar device may be installed at merchant location, and may transmit a signal that, when received by a user device, may trigger an application running on the user device to track the user device's location. After determining the relevant budget category, the system may determine (e.g., via budget management device) the remaining budget amount for that category. The remaining budget amount may then be displayed to the user (e.g., via user device 102) before any purchases have been attempted. After a user has completed shopping and initiates a transaction, system may complete steps similar to those previously described in order to provide the user with budget regulated point of sale alerts.

Further, an additional use case where a user may desire to have the ability to track their budget in real time using budget regulated item selection alerts in addition to the geographic budget alerts and the budget regulated point of sale alerts is presented. As with the prior use cases, the following exemplary use case describes one example of a typical user flow pattern. It is intended solely for explanatory purposes and not in limitation. As previously described, the user may enter budget information. Once the budget information is entered, the user may go shopping. As a user chooses an item to be purchased, merchant item sensor 122 may detect that the item has been placed in the cart. For example, items to be purchased may have an ID tag integrated and merchant item sensor 122 may detect that the item has been placed in the cart. Merchant item sensor 122 may transmit data associated with items to user device 102. The system may determine (e.g., via budget management device 120) a relevant budget category, as previously discussed. Alternatively, as user device 102 receives the data associated with items, user device 102 may prompt the user to select a relevant budget category associated with the items (e.g., after data associated with all the items is received or as data associated with each item is received). After determining the relevant budget category, the system may determine (e.g., via budget management device) a provisional budget amount or the amount that would be left in the relevant budget category if the user were to purchase the item. According to some examples, system may determine whether the provisional budget amount is less than zero. If the provisional budget amount is determined to be less than zero, the system may generate a warning message indicating that authorizing the purchase of the item selected by the user would cause the user to exceed the amount of money budgeted for the relevant budget category. After a user has completed shopping and initiates a transaction, system may complete steps similar to those previously described in order to provide the user with budget regulated point of sale alerts.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

1-2. (canceled)

3. The system of claim 24, wherein the user budget information comprises data indicative of a maximum expenditure over a predetermined time period for items associated with the one or more budget categories.

4. The system of claim 24, wherein the warning message comprises a request to approve the purchase authorization request.

5. The system of claim 24, wherein the instructions are further configured to cause the system to:
receive, from the user device, an authorization;
generate a confirmation message indicating that the merchant device should authorize the attempted purchase; and
transmit, to the merchant device, the confirmation message.

6. The system of claim 24, wherein the instructions are further configured to cause the system to:
receive, from the user device, a cancellation of the attempted purchase;
generate a cancellation message to cause the merchant device to cancel the attempted purchase; and
transmit, to the merchant device, the cancellation message.

7. (canceled)

8. The system of claim 24, wherein the purchase authorization request comprises stock keeping unit data associated with the one or more items.

9. The system of claim 8, wherein the stock keeping unit data is obtained by one of: detecting a beacon, scanning a barcode, scanning a QR code, or capturing an image of the one or more items.

10. The system of claim 5, wherein receiving the confirmation message further comprises:
receiving, from the user device, confirmation that an identity of a user has been verified by the user device in association with the attempted purchase.

11. The system of claim 24, wherein the instructions are further configured to cause the system to:
receive, from the user device, authorization of the attempted purchase;
receive, from the user device, biometric data associated with a user; and
authenticate the user by comparing the biometric data from the user device to stored biometric data.

12. The system of claim 11,
wherein the stored biometric data comprises biometric data associated with an individual associated with a financial account number; and
wherein authenticating the user of the user device comprises:
determining that the biometric data matches, within a predetermined confidence level, the stored biometric data.

13-23. (canceled)

24. A system for providing real time digital budget tracking, the system comprising:
one or more processors; and
a memory in communication with the one or more processors and storing instructions that, when executed by the one or more processors, are configured to cause the system to:
receive, from a user device, user budget information comprising one or more budget categories;
obtain, from a location sensor of the user device, location data including a global positioning system (GPS) location for the user device;
determine a merchant location based on the location data, the merchant location comprising a geofence defining the merchant location;
determine a first budget category of the one or more budget categories based on the merchant location, the first budget category having a first budget;
receive, from an item sensor integrated into a shopping cart, potential purchase data associated with a selected item, the item sensor comprising a digital camera and an optical scanner, and the potential purchase data including an image of the selected item obtained by the digital camera and barcode data associated with the selected item obtained by the optical scanner;
subtract a value associated with the selected item from the first budget to obtain a provisional budget, the value being obtained from the barcode data;
determine that the provisional budget is less than zero;
transmit a first signal to the user device to cause the user device to display a warning message, the warning message including the provisional budget;
receive, from a merchant device, a purchase authorization request for an attempted purchase, the purchase authorization request comprising a transaction amount and one or more items;
determine that the transaction amount is less than the provisional budget;
approve the purchase authorization request;
generate an authorization message including the provisional budget;
send a second signal to the user device to cause the user device to display the authorization message; and
store the provisional budget as the first budget in the user budget information.

25. A method for providing real time digital budget tracking, comprising:
receiving, from a user device, user budget information comprising one or more budget categories;
obtaining, from a location sensor of the user device, location data including a global positioning system (GPS) location for the user device;
determining a merchant location based on the location data, the merchant location comprising a geofence defining the merchant location;
determining a first budget category of the one or more budget categories based on the merchant location, the first budget category having a first budget;
receiving, from an item sensor integrated into a shopping cart, potential purchase data associated with a selected item, the potential purchase data including an image of the selected item and barcode data associated with the selected item;
subtracting a value associated with the selected item from the first budget to obtain a provisional budget, the value being obtained from the barcode data;
determining that the provisional budget is less than zero;
transmitting a first signal to the user device to cause the user device to display a warning message, the warning message including the provisional budget;
receiving, from a merchant device, a purchase authorization request for an attempted purchase, the purchase authorization request comprising a transaction amount and one or more items;
determining that the transaction amount is less than the provisional budgets;
authorizing the purchase authorization request;
generating an authorization message including the provisional budget;
transmitting a second signal to the user device to cause the user device to display the authorization message; and
storing the provisional budget as the first budget in the user budget information.

26. The method of claim 25, wherein the user budget information includes a maximum expenditure over a predetermined time period for items associated with the one or more budget categories.

27. The method of claim 25, wherein the warning message comprises a request to approve the purchase authorization request.

28. The method of claim 25, further comprising:
receiving, from the user device, an authorization;
generating a confirmation message indicating that the merchant device should authorize the attempted purchase; and
transmitting, to the merchant device, the confirmation message.

29. The method of claim 28, wherein the receiving the confirmation message further comprises:
receiving, from the user device, confirmation that an identity of a user has been verified by the user device in association with the attempted purchase.

30. The method of claim 25, further comprising:
receiving, from the user device, a cancellation of the attempted purchase;
generating a cancellation message to cause the merchant device to cancel the attempted purchase; and
transmitting, to the merchant device, the cancellation message.

31. The method of claim 25, wherein the purchase authorization request comprises stock keeping unit data associated with the one or more items.

32. The method of claim 31, wherein the stock keeping unit data is obtained by one of: detecting a beacon, scanning a barcode, scanning a QR code, or capturing an image of the one or more items.

33. The method of claim 25, further comprising:
receiving, from the user device, authorization of the attempted purchase;
receiving, from the user device, biometric data associated with a user; and
authenticating the user by comparing the biometric data from the user device to stored biometric data.

34. The method of claim 33, wherein authenticating the user comprises:
comparing the biometric data from the user device to the stored biometric data, wherein the stored biometric data comprises biometric data associated with an individual and a financial account number; and
determining that the biometric data matches, within a predetermined confidence level, the stored biometric data.
